(19) United States
(12) Patent Application Publication
(10) Pub. No.: US 2008/0118016 A1
(43) Pub. Date: May 22, 2008

(54) Synchronous circuit of receiving device of wireless transmission system

(76) Inventors: Yu-Min Chuang, Hsinchu City (TW); Fu-Min Yeh, Taoyuan City (TW); Juinn-Horng Deng, Pingjhen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/601,744

(22) Filed: Nov. 20, 2006

(51) Int. Cl. H04L 7/00; H04L 27/00

(52) U.S. Cl. 375/359; 375/340

(57) ABSTRACT

A synchronous circuit of a receiving device of a wireless transmission system composed of a delaying unit, a multiplier, a matched filter and a checking unit is disclosed. The delaying unit receives a preamble of a baseband signal and delays the preamble that includes a plurality of symbols. Through the multiplier, the symbols of the preamble are multiplied by the symbols of the preamble delayed by the delaying unit so as to generate a plurality of matched data. Then the matched filter matches and filters the matched data to generate a plurality of output data according to a plurality of matched parameters. At last, the checking unit checks these output data to obtain the maximum output data and the corresponding symbol so as to generate a synchronous signal. Therefore, the receiving device demodulates the baseband signal and obtains the data correctly.

### BACKGROUND OF THE INVENTION

The present invention relates to a synchronous circuit, especially to a synchronous circuit of a receiving device of a wireless transmission system.

Generally in wireless transmission systems, symbol timing offset and carrier frequency offset have negative effect on efficiency of the system such as OFDM (Orthogonal Frequency Division Multiplexing) system. Moreover, such offset may make starting point of Fast Fourier Transform (FFT) fall on a previous symbol so that intersymbol interference happen due to demodulation of data in the next symbol.

Refer to FIG. 1, conventional synchronous circuit includes a delay unit 221′, a multiplier 222′ and a checking unit 223′. The delay unit 221′ receives a preamble data of a baseband signal and delays the preamble data while the multiplier 222′ multiplies the preamble data by the delayed permeable processed by the delay unit 221 ′ and transmits the data to the checking unit 223′ so as to generate a synchronous signal according which the receiving device receives the data while intersymbol interference is avoided.

However, before being sent to the receiving device, most of the preamble is modulated by a transmitting device of the wireless transmission system. According to a cover sequence, the transmitting device modulates the preamble so as to improve transmitting efficiency of the wireless transmission system. The preamble is a preamble symbol that includes 24 identical symbols. The baseband signal further includes a header symbol and a payload symbol. The header symbol includes parameters for effective data such as encoding rate and data length. Effective data means data actually transmitted by the transmitting device. There are seven kinds of Pico Net between the transmitting device (transmitter) and the receiving device (receiver) of the wireless transmission system for sending packet data. Each symbol inside the piconet is defined to have different frequency-hopping way to transmit data. The first piconet and the second piconet take three clock signal (symbol period) to turn back to the same frequency band while the third piconet, the fourth piconet, the fifth piconet, the sixth piconet and the seventh piconet take only one clock signal (symbol period) to turn back to the same frequency band.

Moreover, the RF signal includes a preamble data that multiplies by a cover sequence. This also leads to frequency offset that makes the receiving device receive wrong data and unable to demodulate the received data correctly.

Thus there is a need to provide a novel synchronous circuit for a receiving device of a wireless transmission system that improves frequency offset and further prevents data interpretation problem.

### SUMMARY OF THE INVENTION

Therefore it is a primary object of the present invention to provide a synchronous circuit of a receiving device of a wireless transmission device that obtains a synchronous signal through a matched filter and a checking unit so as to make the receiving device demodulate RF signal from the transmitting device of the wireless transmission system correctly.

A synchronous circuit of a receiving device of a wireless transmission device according to the present invention consists of a delaying unit, a multiplier, a matched filter and a checking unit. The delaying unit receives a preamble of a baseband signal and delays the preamble that includes a plurality of symbols. A transmitting device of the wireless transmission system modulates the preamble according to a cover sequence. The multiplier multiplies the symbols of the preamble by the symbols of the delayed preamble delayed by the delaying unit so as to generate a plurality of matched data. Then the matched filter matches and filters the matched data to generate a plurality of output data according to a plurality of matched parameters. The matched parameters correspond to cover sequence of delayed symbols as well as undelayed symbols multiplied by the multiplier. The checking unit checks these output data to obtain the maximum output data and the corresponding symbol so as to generate a synchronous signal.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a conventional synchronous circuit;

FIG. 2 is a block diagram of an embodiment of a wireless transmission system according to the present invention;

FIG. 3 is a block diagram of an embodiment according to the present invention;

FIG. 4A is a list of cover sequence of the preamble accoding to the present invention;

FIG. 4B & FIG. 4C are showing a list of matched parameters of each piconet according to the present invention.

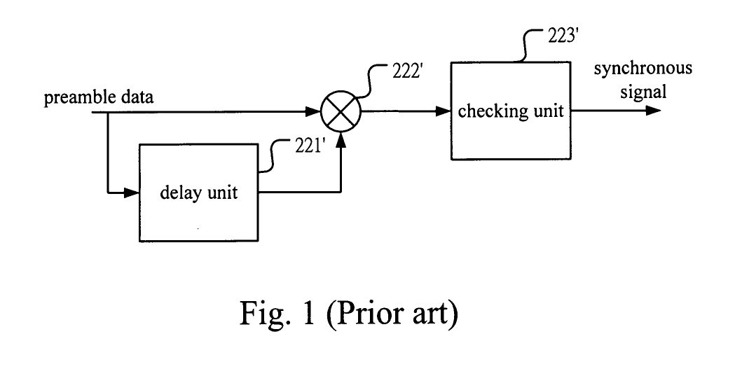

### DETAILED DESCRIPTION OF THE PREFERRED EMBODIMENT

The present invention estimate frequency toward the frequency estimator of the preamble having a cover sequence in a receiving device of a wireless transmission system so as to obtain correct frequency offset. The following embodiment is using a Multi-Band Orthogonal Frequency Division Multiplexing Ultra Wide Band (MB-OFDM UWB) system as an example but not limited to this system.

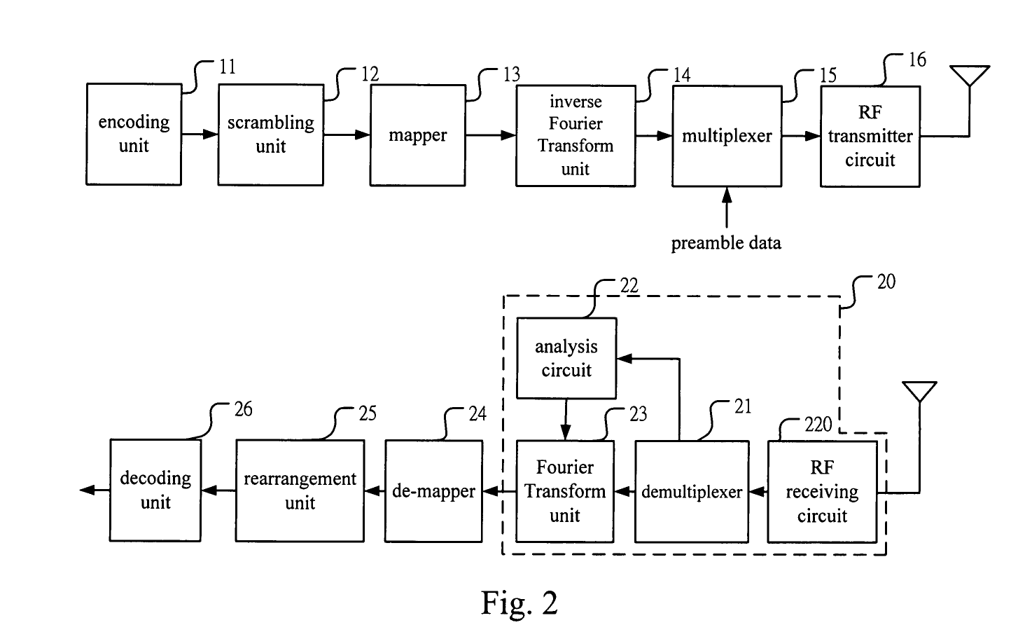

Refer to FIG. 2, the transmission system includes a encoding unit 11, a scrambling unit 12, a mapper 13, an inverse Fourier Transform unit 14, a multiplexer 15 and a RF(radio frequency) transmitter circuit 16. The encoding unit 11 is for receiving and encoding an input signal while the scrambling unit 12 tumbles the input signal decoded by the encoding unit 11 so as to regularize noise. The mapper 13 maps the signal tumbled by the scrambling unit 12 while the Fourier Transform unit 14 converts signal from frequency domain signal to time domain signal. The multiplexer 15 receives the time domain signal and a preamble so as to generate a frequency-hop sequence signal to the RF transmitter circuit 16. The frequency-hop sequence signal is converted to a RF signal by the RF transmitter circuit 16 and the RF signal is sent by a transmitting antenna.

The receiving device is composed of a frequency-hop analysis circuit 20, a Fourier Transform unit 23, a de-mapper 24, a rearrangement unit 25 and a decoding unit 26. A RF receiving circuit 220 of the frequency-hop analysis circuit 20 receives a RF signal from a transmitting device according to a frequency-hop sequence and then down-converts the RF signal to lower frequency to generate a baseband signal. A demultiplexer 21 receives the baseband signal and respectively sends a preamble to an analysis circuit 22 as well as a header together with payload to the Fourier Transform unit 23.

The analysis circuit 22 receives and analyzes the preamble so as to learn a synchronous signal that is sent to the Fourier Transform unit 23. According to the synchronous signal, the header and payload are received and converted into frequency domain signal. The de-mapper 24 processes the frequency domain signal converted by the Fourier Transform unit 23 and transmits the signal to the rearrangement unit 25. After being rearranged, the processed signal is decoded by the decoding unit 26 so that the data transmission is finished.

A synchronous circuit is further disposed on the analysis circuit 22 according to the present invention for generating a synchronous signal that makes the fast Fourier Transform unit 23 of the receiving device receive the header and the payload at the same time so as to avoid errors on data receiving. The synchronous circuit of the receiving device of the wireless transmission device is described in the following.

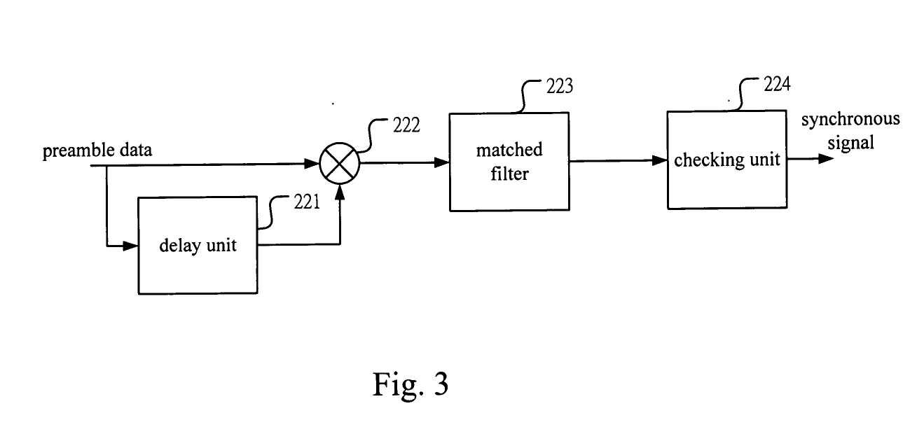

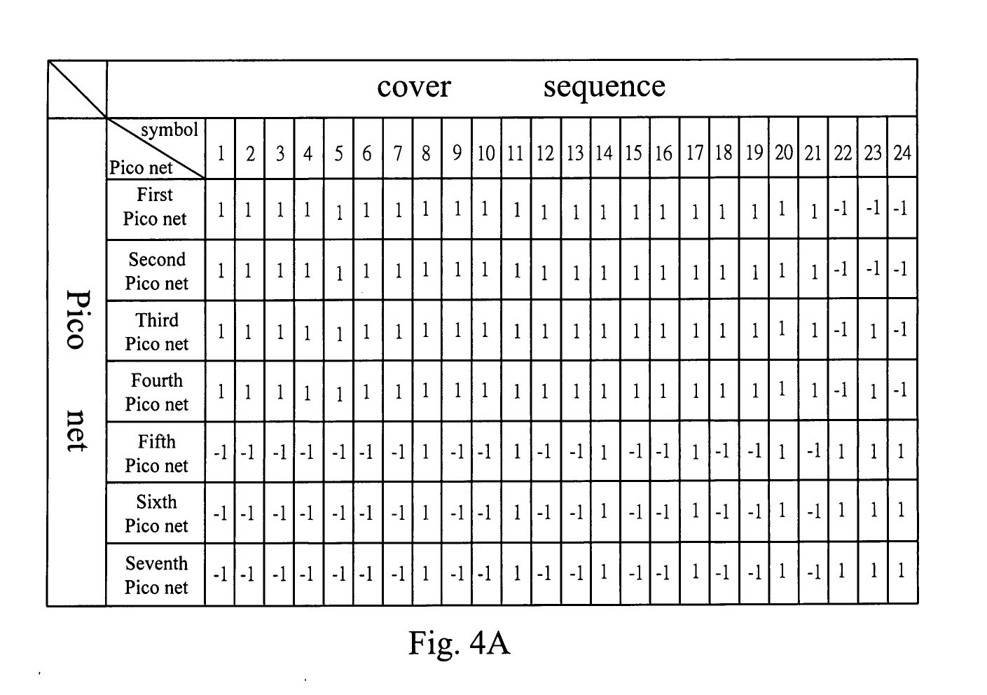

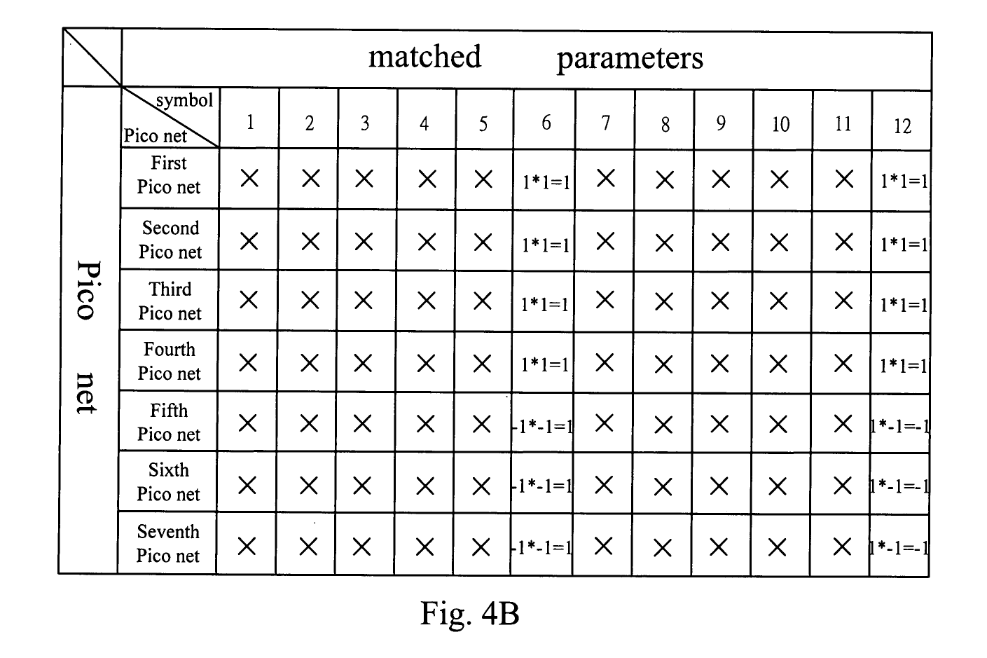

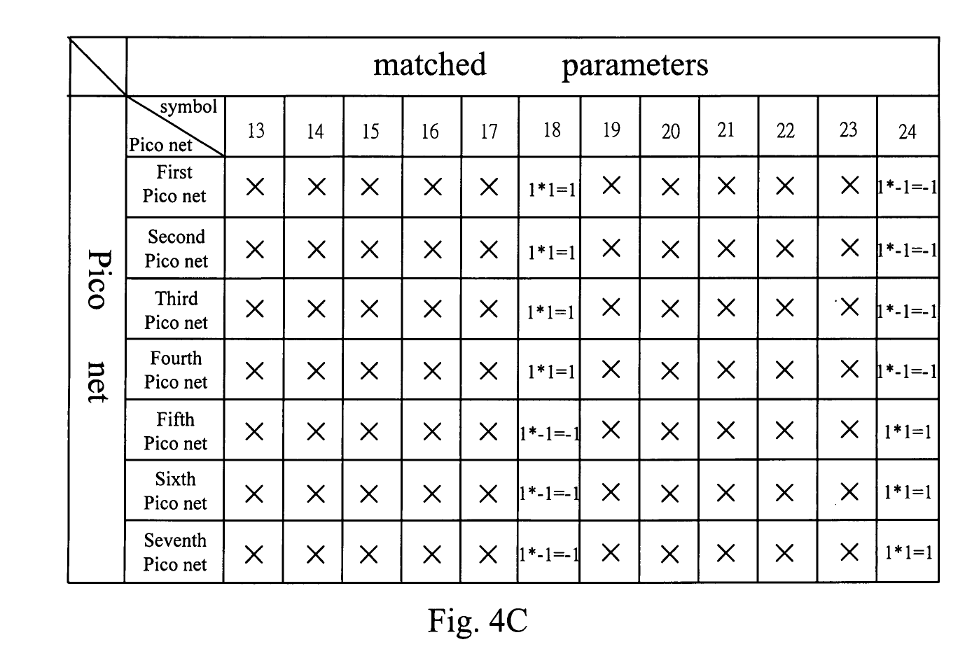

Refer to FIG. 3, a synchronous circuit of the receiving device of the wireless transmission device according to the present invention consists of a delaying unit 221, a multiplier 222, a matched filter 223 and a checking unit 224. The delaying unit 221 receives a preamble of a baseband signal and delays the preamble that includes a plurality of symbols. A transmitting device of the wireless transmission system modulates the preamble according to a cover sequence, as shown in FIG. 4A. The multiplier 222 multiplies the symbols of the preamble by the symbols of the preamble delayed by the delaying unit 221 so as to generate a plurality of matched data.

According to a plurality of matched parameters, the matched filter 223 matches and filters the matched data to generate a plurality of output data. The matched parameters correspond to cover sequence of undelayed symbols as well as cover sequence of the delayed symbols multiplied by the multiplier 222. Then the checking unit 224 checks these output data to obtain the maximum output data and the corresponding symbol so as to generate a synchronous signal. Thus the timing of the 24^{th} boundary symbol of the preamble is detected. The fast Fourier Transform unit 23 of the receiving device receives the following header and the payload according to the synchronous signal. Therefore, the receiving device demodulates the RF signal transmitted from the transmitting device of the wireless transmission system correctly.

Moreover, the matched parameter is product of cover sequence of the symbols before being delayed by the delaying unit 221 and cover sequence of the delayed symbols with 3 clock signal delay by the delaying unit 221. That's preamble of the first piconet or the second piconet. Or the matched parameter is product of cover sequence of the symbols before being delayed by the delaying unit 221 and cover sequence of the delayed symbols with 1 clock signal delay by the delaying unit 221. That's preamble of the third piconet, the fourth piconet, the fifth piconet, the sixth piconet and the seventh piconet.

Furthermore, the matched parameter is obtained from multiplication of cover sequence of the sixth, the twelfth, the eighteenth, the twenty-fourth symbols and cover sequence of the delayed symbols. Thus all boundary of preamble in seven kinds of piconet can be detected. That means the 24^{th} boundary symbol of the preamble is detected. For the piconet from the third to the seventh, the matched parameters are respectively multiplications of the cover sequence of the 6^{th}, 12^{th}, 18^{th}, 24^{th} symbols and cover sequence of the 5^{th}, 11^{th}, 17^{th} and 23^{rd} symbols delayed by the delaying unit 221. While in the first piconet or the second piconet, the matched parameters are respectively multiplications of the cover sequence of the 6^{th}, 12^{th}, 18^{th}, 24^{th} symbols and cover sequence of the 3^{rd}, 9^{th}, 15^{th} and 21^{st} symbols delayed by the delaying unit 221.

A synchronous circuit of a receiving device receives a baseband signal having a presmise with a cover sequence while the mth preamble received by it is shown as following equation:

rₘ=αcₘpexp{j2πΔfmNTₛ}+nₘ
wherein

wherein α is attenuation value of wireless transmission channels;

cₘ is mth cover sequence;

Δf is frequency offset;

N is number of preamble data having cover sequence;

Tₛ is sampling period;

nₘ is AWGN Noise;

p is preamble with frequency offset and is shown as following:

p=[p₀p₁e^{j2πΔfT,}p₂e^{j2πΔf2T,} . . . pₙ₋₁e^{j2πΔf(N-1)T}^{ₛ}]^{T}

wherein pₙ is the nth preamble sequence of the preamble;

The delaying unit 221 delays the preamble so as to obtain the (m+D)th preamble and the multiplier 222 multiplies the preamble by the (m+D)th preamble to generate a first data that is shown as:

$$\begin{matrix}{y}_{m} = {r}_{m}^{H} {r}_{m + D} = {\vert α \vert}^{2} ( {c}_{m}^{*} {c}_{m + D} ) ( {p}^{H} p ) {e}^{j2πΔ {fDNT}_{s}} + {\tilde{n}}_{m} \\ = {e}^{j2πΔ {fDNT}_{s}} ( {c}_{m}^{*} {c}_{m + D} ) {\vert α \vert}^{2} {\sum }_{n = 0}^{N - 1} {\vert {p}_{n} \vert}^{2} + {\tilde{n}}_{m}\end{matrix}$$

D can be one clock signal or three clock signal delayed by the delaying unit 221; when D=1:

$${y}_{m} = {e}^{j2πΔ {fNT}_{s}} ( {c}_{m}^{*} {c}_{m + 1} ) {\vert α \vert}^{2} {\sum }_{n = 0}^{N - 1} {\vert {p}_{n} \vert}^{2} + {\tilde{n}}_{m}$$

or when D=3

$${y}_{m} = {e}^{j2πΔ f 3 {NT}_{s}} ( {c}_{m}^{*} {c}_{m + 3} ) {\vert α \vert}^{2} {\sum }_{n = 0}^{N - 1} {\vert {p}_{n} \vert}^{2} + {\tilde{n}}_{m}$$

wherein it is learned through the yₘ that cₘ*cₘ₊₁ or cₘ*cₘ₊₃ will change along with the number of the symbol-m. Thus cₘ*cₘ₊₁ or cₘcₘ₊₃ is used as matched parameter and the matched filter 223 detects boundary of the preamble. Furthermore, the checking unit 224 generates a synchronous signal. The matched filter 223 is shown as following:

$${\hat{t}}_{n} = {arg}_{n} max \{ {\vert {\sum }_{m = 0}^{M - 1} {{y}_{n + m} ( {c}_{m}^{*} {c}_{m + D} )}^{*} \vert}^{2} \}$$

Moreover, in order to make various piconet, seven poconets in FIG. 4B & FIG. 4C, match the same matched parameters, the number of matched parameters in above equation is defined as four, m+D=6k , k=1, 2, 3, 4. That means the 6^{th}, 12^{th}, 18^{th}, and 24^{th} matched parameters are selected.

$${\hat{t}}_{n} = {arg}_{n} max \{ {\vert {\sum }_{k = 1}^{4} {{y}_{n + 6 k - D} ( {c}_{6 k - D}^{*} {c}_{6 k} )}^{*} \vert}^{2} \}$$

In addition, the matched parameters are not restricted to these four numbers. This is just one of the embodiments.

In summary, a synchronous circuit of a receiving device of a wireless transmission in accordance with the present invention consists of a delaying unit, a multiplier, a matched filter and a checking unit. The delaying unit delays preamble that includes a plurality of symbols. Through the multiplier, the symbols of the preamble are multiplied by the symbols of the delayed preamble so as to generate a plurality of matched data. Then the matched filter matches and filters the matched data to generate a plurality of output data according to a plurality of matched parameters. Finally, the checking unit checks these output data to obtain the maximum output data and the corresponding symbol so as to generate a synchronous signal. Therefore, the receiving device demodulates the RF signal transmitted from the transmitting device of the wireless transmission system correctly.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A synchronous circuit of a receiving device of a wireless transmission system comprising:
a delaying unit that receives a preamble of a baseband signal and delays the preamble that includes a plurality of symbols; the preamble is modulated by a transmitting device of the wireless transmission system in accordance with a cover sequence;
a multiplier that multiplies the symbols of the preamble by the symbols of the delayed preamble that is delayed by the delaying unit to generate a plurality of matched data;
a matched filter that matches and filters the matched data to generate a plurality of output data according to a plurality of matched parameters while the matched parameters correspond to cover sequence of the undelayed symbols and cover sequence of the delayed symbols multiplied with each other by the multiplier; and
a checking unit that checks the output data to obtain the maximum output data and symbol corresponding to the maximum output data so as to generate a synchronous signal.

2. The synchronous circuit as claimed in claim 1, wherein for a first piconet and a second piconet, the delaying unit delays the preamble three clock signal.

3. The synchronous circuit as claimed in claim 2, wherein the matched parameters are products of cover sequence of the symbols before being delayed by the delaying unit and cover sequence of the delayed symbols with three clock signal delay by the delaying unit.

4. The synchronous circuit as claimed in claim 3, wherein the matched parameters respectively are products of cover sequence of the 6^{th}, 12^{th}, 18^{th}, 24^{th} symbols and cover sequence of the 3^{rd}, 9^{th}, 15^{th} and 21^{st} symbols delayed by the delaying unit.

5. The synchronous circuit as claimed in claim 1, wherein for a third piconet, a fourth piconet, a fifth piconet, a sixth piconet and a seventh piconet, the delaying unit delays the preamble one clock signal.

6. The synchronous circuit as claimed in claim 5, wherein the matched parameters are products of cover sequence of the symbols before being delayed by the delaying unit and cover sequence of the delayed symbols with one clock signal delay by the delaying unit.

7. The synchronous circuit as claimed in claim 6, wherein the matched parameters respectively are products of cover sequence of the 6^{th}, 12^{th}, 18^{th}, 24^{th} symbols and cover sequence of the 5^{th}, 11^{th}, 17^{th} and 23^{rd} symbols delayed by the delaying unit.

8. The synchronous circuit as claimed in claim 1, wherein a RF receiving circuit of the receiving device receives a RF signal from a transmitting device of the wireless transmission system according to a frequency-hop sequence and then down-converts the RF signal to lower frequency to generate the baseband signal.

9. The synchronous circuit as claimed in claim 1, wherein the wireless transmission system is a Multi-Band Orthogonal Frequency Division Multiplexing Ultra Wide Band (MB-OFDM UWB) system.
